(19) United States
(12) Patent Application Publication
(10) Pub. No.: US 2025/0377579 A1
(43) Pub. Date: Dec. 11, 2025

(54) CAMERA MODULE AND ELECTRONIC DEVICE

(71) Applicant: AAC Acoustic Technologies (Shanghai) Co., Ltd., Shanghai (CN)

(72) Inventors: Chengxiang Shu, Shanghai (CN); Aixin Xu, Shanghai (CN)

(21) Appl. No.: 19/001,633

(22) Filed: Dec. 26, 2024

Related U.S. Application Data
(63) Continuation of application No. PCT/CN2024/097555, filed on Jun. 5, 2024.

(51) Int. Cl. G03B 13/36; G03B 5/00

(52) U.S. Cl. CPC G03B 13/36; G03B 5/00; G03B 2205/0046; G03B 2205/0061

(57) ABSTRACT

The present application provides a camera module and an electronic device. The camera module includes a housing having an accommodating cavity, a first piezoelectric motor and a second piezoelectric motor provided within the accommodating cavity, a first lens assembly connected to the first piezoelectric motor and provided within the accommodating cavity, a second lens assembly connected to the second piezoelectric motor and provided within the accommodating cavity, and a guide member fixed to the housing and provided within the accommodating cavity. The first piezoelectric motor is configured to drive the first lens assembly to move along a lengthwise direction of the guide member, and the second piezoelectric motor is configured to drive the second lens assembly to move along the lengthwise direction of the guide member. In the present application, the camera module has both continuous optical zoom and autofocus functions.

### CROSS-REFERENCE TO RELATED APPLICATIONS

This application is a continuation of International Application No. PCT/CN2024/097555, filed Jun. 5, 2024, the entire contents of which is incorporated herein by reference.

### TECHNICAL FIELD

The present application relates to the field of camera technologies, in particular to a camera module and an electronic device.

### BACKGROUND

The camera module of a mobile phone generally employs a voice coil motor (VCM) to drive the lens travel, for example, to drive the lens travel during autofocus (AF). The voice coil motor is provided with a coil and a permanent magnet, and the voice coil motor is an electromagnetic drive source.

In the related art, the driving stroke of the VCM is increased from AF (0.5 mm) to optical zoom (4 mm) or so after the introduction of continuous optical zoom function in mobile phones, significantly extending the lens travel distance. However, the driving force of the voice coil motor is weak, making it difficult to meet the demand for long lens travel.

Therefore, it is necessary to provide a new camera module.

### SUMMARY

The purpose of the present application is to provide a camera module and an electronic device, which can solve the technical problem in the related art that the voice coil motor is difficult to meet the demand of the lens long stroke.

The technical solution of the present application is as follows:

A camera module comprising a housing having an accommodating cavity, a first piezoelectric motor and a second piezoelectric motor provided within the accommodating cavity, a first lens assembly connected to the first piezoelectric motor and provided within the accommodating cavity, a second lens assembly connected to the second piezoelectric motor and provided within the accommodating cavity, and a guide member fixed to the housing and provided within the accommodating cavity, wherein the first lens assembly and the second lens assembly are spaced apart and both slidingly assembled to the guide member; the first piezoelectric motor is configured to drive the first lens assembly to move along a lengthwise direction of the guide member, and the second piezoelectric motor is configured to drive the second lens assembly to move along the lengthwise direction of the guide member

In one embodiment, the first piezoelectric motor comprises a first actuator assembly fixed to the first lens assembly, a first pressing assembly fixed to the first actuator assembly and enclosing a first holding cavity with the first actuator assembly, a first stator assembly in contact with the first actuator assembly and the first pressing assembly and provided within the first holding cavity, and a first friction member in contact with the first actuator assembly and the first stator assembly and provided within the first accommodating cavity, wherein the first pressing assembly is configured to press the first actuator assembly and the first stator assembly against the first friction member, and the first stator assembly is configured to drive the first actuator assembly to move along the lengthwise direction of the guide member.

In one embodiment, the first actuator assembly comprises a first guide rail fixed to the first lens assembly and the first pressing assembly, and a first ball in contact with the first friction member and the first guide rail, wherein the first guide rail is provided with a first holding groove, and the first ball is provided within the first holding groove.

In one embodiment, the first pressing assembly comprises a first side plate fixed to the first guide rail, a second side plate fixed to the first side plate and provided directly opposite to the first guide rail, a third side plate fixed to the second side plate and connected to the first guide rail, and a first elastic piece provided on the second side plate and in contact with the first stator assembly, wherein the first guide rail, the first side plate, the second side plate, and the third side plate together enclose to form the first holding cavity.

In one embodiment, the first stator assembly comprises a first elastomer in contact with the first friction member, and a first piezoelectric ceramic body fixed to a side of the first elastomer away from the first friction member; wherein the first piezoelectric motor further comprises a first circuit board fixed to a side of the first piezoelectric ceramic body away from the first elastomer and in contact with the first pressing assembly, and the first circuit board is electrically connected to the first piezoelectric ceramic body.

In one embodiment, the first elastomer comprises a first base portion in contact with the first piezoelectric ceramic body, and first resilient portions fixed to the first base and in contact with the first friction member; wherein there are a plurality of the first resilient portions, and the plurality of the first resilient portions are provided in spaced arrays.

In one embodiment, the second piezoelectric motor comprises a second actuator assembly fixed to the second lens assembly, a second pressing assembly fixed to the second actuator assembly and enclosing to form a second holding cavity with the second actuator assembly, a second stator assembly in contact with the second actuator assembly and the second pressing assembly and provided within the second holding cavity assembly, and a second friction member in contact with the second actuator assembly and the second stator assembly and provided within the second accommodating cavity, wherein the second pressing assembly is configured to press the second actuator assembly and the second stator assembly against the second friction member, and the second stator assembly is configured to drive the second actuator assembly to move along the lengthwise direction of the guide member.

In one embodiment, the first lens assembly is provided with a first mounting cavity, and the second lens assembly is provided with a second mounting cavity; the first mounting cavity is coaxially disposed with the second mounting cavity, and the guide member is slidingly assembled within the first mounting cavity and the second mounting cavity.

In one embodiment, the camera module further comprises a first position sensor fixed to the housing and provided within the accommodating cavity, and a second position sensor fixed to the housing and provided within the accommodating cavity, wherein a detecting direction of the first position sensor is directed toward the first lens assembly, and a detecting direction of the second position sensor is directed toward the second lens assembly.

An electronic device comprising an device body and a camera module mounted in the device body and as described in any one of the above.

The beneficial effect of the present application is that one of the first lens assembly and the second lens assembly is an autofocus lens, and the other is an optical zoom lens. The first lens assembly is set to be driven to move by the first piezoelectric motor, and the second lens assembly is set to be driven to move by the second piezoelectric motor. Since the piezoelectric motor has a strong driving force and driving speed, it can satisfy the demand for a long traveling distance of the optical zoom lens, thus making the camera module has both continuous optical zoom and autofocus functions.

### BRIEF DESCRIPTION OF THE DRAWINGS

FIG. 1 is an overall structural schematic diagram of a camera module according to an embodiment of the present application.

FIG. 2 is a sectional view of the camera module in FIG. 1 in the A-A direction.

FIG. 3 is an enlarged view of detail B in FIG. 2.

FIG. 4 is an enlarged view of detail C in FIG. 2.

FIG. 5 is an exploded view of a first piezoelectric motor in the camera module according to an embodiment of the present application.

FIG. 6 is a structural schematic diagram of a first elastomer in the camera module according to an embodiment of the present application.

### DETAILED DESCRIPTION OF THE EMBODIMENTS

The present application is further described below in conjunction with the accompanying drawings and embodiments.

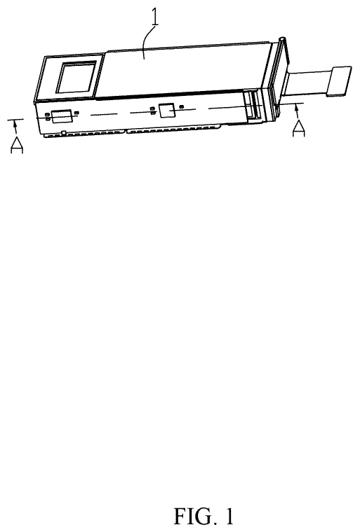

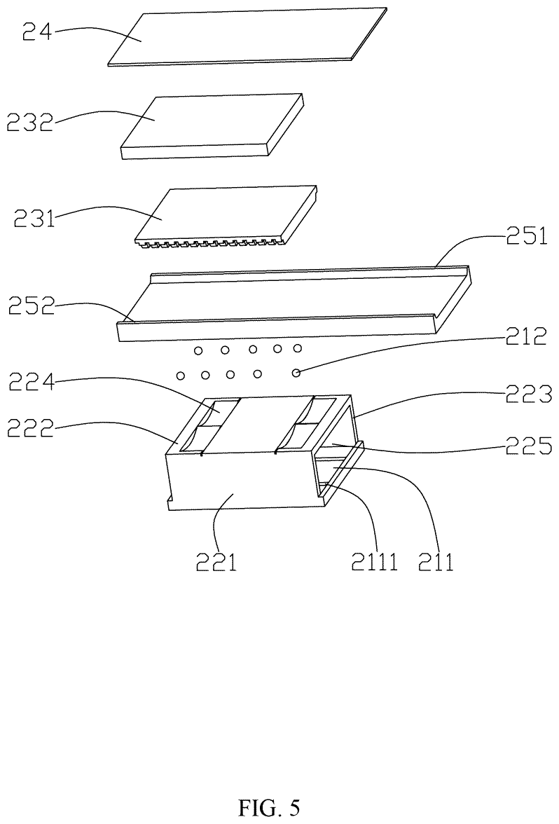

As shown in FIGS. 1 to 6, the present application provides an electronic device including a device body and a camera module arranged in the device body. The camera module includes a housing 1 having an accommodating cavity 11, a first piezoelectric motor 2 and a second piezoelectric motor 3 disposed in the accommodating cavity 11, a first lens assembly 4 connected to the first piezoelectric motor 2 and provided within the accommodating cavity 11, a second lens assembly 5 connected to the second piezoelectric motor 3 and provided within the accommodating cavity 11, and a guide member 6 fixed to the housing 1 and provided within the accommodating cavity 11. The first lens assembly 4 and the second lens assembly 5 are spaced apart and both slidingly assembled to the guide member 6. The first piezoelectric motor 2 is configured to drive the first lens assembly 4 to move along a lengthwise direction of the guide member 6, and the second piezoelectric motor 3 is configured to drive the second lens assembly 5 to move along the lengthwise direction of the guide member 6.

One of the first lens assembly 4 and the second lens assembly 5 is an autofocus lens, and the other is an optical zoom lens. The first lens assembly 4 is set to be driven to move by the first piezoelectric motor 2, and the second lens assembly 5 is set to be driven to move by the second piezoelectric motor 3. Since the piezoelectric motor has a strong driving force and driving speed, it can satisfy the demand for a long travel of the optical zoom lens, thus making the camera module have both continuous optical zoom and autofocus functions.

It should be noted that the electronic device may be a mobile phone or a tablet computer. The first lens assembly 4 may be an autofocus lens, the second lens assembly 5 may be an optical zoom lens, the first lens assembly 4 is in the front and the second lens assembly 5 is in the back. The lengthwise direction of the guide member 6 extends along the direction of an optical axis of the camera module. Since both the first lens assembly 4 and the second lens assembly 5 slide along the lengthwise direction of the guide member 6, it can be ensured that the movement trajectory of the first lens assembly 4 and the second lens assembly 5 is consistent, realizing the unification of the optical axis.

As shown in FIGS. 1, 2, and 3, the first piezoelectric motor 2 includes a first actuator assembly 21 fixed to the first lens assembly 4, a first pressing assembly 22 fixed to the first actuator assembly 21 and enclosing a first holding cavity 225 with the first actuator assembly 21, a first stator assembly 23 in contact with the first actuator assembly 21 and the first pressing assembly 22 and is provided within the first holding cavity 225, and a first friction member 25 in contact with the first actuator assembly 21 and the first stator assembly 23 and provided within the first holding cavity 225. The provision of the first friction member 25 reduces wear and tear resulting from relative movement between the first actuator assembly 21 and the first stator assembly 23, and improves the service life of the piezoelectric motor. The first pressing assembly 22 is configured to press the first actuator assembly 21 and the first stator assembly 23 against the first friction member 25 to bring the first actuator assembly 21 and the first stator assembly 23 into close contact under pressure, causing the first actuator assembly 21 to move in the lengthwise direction of the guide member 6 under the friction between the first actuator assembly 21 and the first stator assembly 23. The first stator assembly 23 is configured to drive the first actuator assembly 21 to move along the lengthwise direction of the guide member 6, and the first actuator assembly 21 drives the first lens assembly 4 to move, realizing automatic zooming of the first lens assembly 4.

According to practical needs, the first friction member 25 may be a sheet plastic plate, and the sheet plastic plate is made of a wear-resistant material. The wear-resistant material may be a polymer, for example, made of polyamide or certain resins by gluing aromatic polyamide fibers.

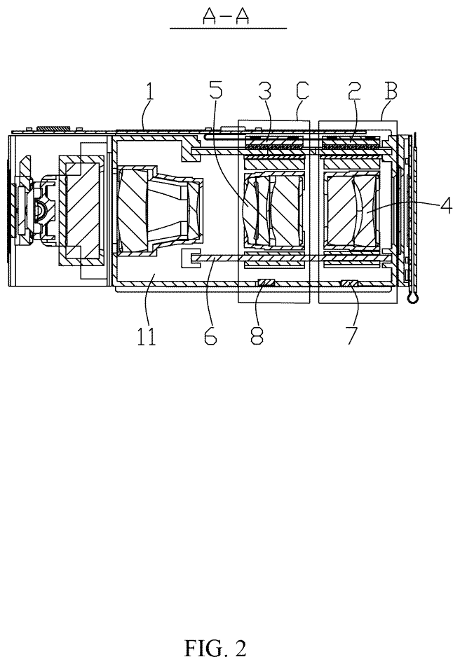

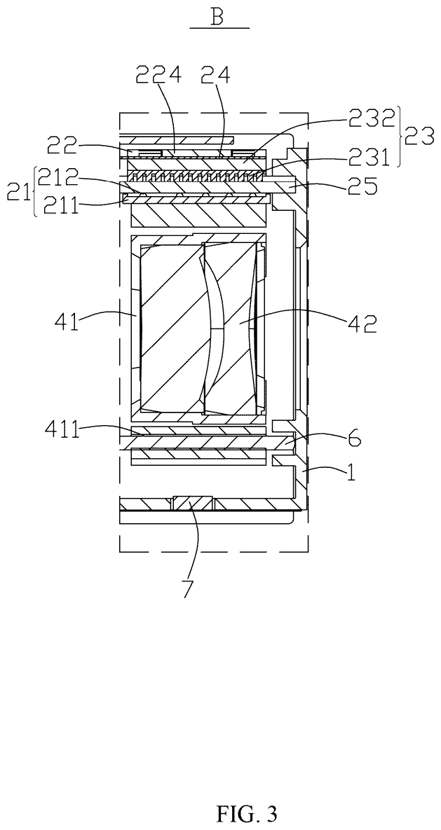

As shown in FIGS. 2 and 3, the first actuator assembly 21 includes a first guide rail 211 fixed to the first lens assembly 4 and the first pressing assembly 22, and a first ball 212 in contact with the first friction member 25 and the first guide rail 211. The first guide rail 211 is provided with a first accommodating groove 2111, and the first ball 212 is provided within the first accommodating groove 2111. Specifically, the first lens assembly 4 includes a first lens barrel 41 slidably assembled to the guide member 6 and provided within the accommodating cavity 11, and a plurality of first lenses 42 mounted within the first lens barrel 41, which are distributed along the optical axis of the camera module. The first guide rail 211 is fixedly connected to an outer side of the first lens barrel 41 so as to enable the first lens assembly 4 to follow the movement of the first actuator assembly 21, thereby realizing the automatic zoom of the first lens assembly 4. The first ball 212 is set in the first accommodating groove 2111 of the first guide rail 211 to form a ball guide structure, thereby enhancing the smoothness of the movement of the first actuator assembly 21. The lengthwise direction of the first accommodating groove 2111 extends along the lengthwise direction of the guide member 6.

According to practical needs, the first guide rail 211 may be a metal plate. There may be a plurality of the first accommodating groove 2111, which are spaced apart along the lengthwise direction perpendicular to the guide member 6. A plurality of first balls 212 may be provided in any one of the first accommodating grooves 2111, for example, there may be two first accommodating grooves 2111, and five first balls 212 are provided in each of the first accommodating grooves 2111.

As shown in FIGS. 2, 3, and 4, the first pressing assembly 22 includes a first side plate 221 fixed to the first guide rail 211, a second side plate 222 fixed to the first side plate 221 and provided directly opposite to the first guide rail 211, a third side plate 223 fixed to the second side plate 222 and connected to the first guide rail 211, and a first elastic piece 224 provided on the second side plate 222 and in contact with the first stator assembly 23. The first guide rail 211, the first side plate 221, the second side plate 222, and the third side plate 223 together enclose to form a first holding cavity 225. The first side plate 221 is provided opposite to the third side plate 223, and the first pressing assembly 22 may provide a preload force by the rebound force of the first elastic piece 224 so as to tightly squeeze the first actuator assembly 21 and the first stator subassembly 23 together. The first elastic piece 224 is provided to be in a rebound state, and the first elastic piece 224 resists the first stator assembly 23, such that the first elastic piece 224 can provide a rebound force to the first stator assembly 23 with the direction of the force applied towards the first actuator assembly 21, thereby tightly squeezing the first stator assembly 23 and the first actuator assembly 21 together.

According to the practical need, there may be a plurality of the first elastic pieces 224, such as two, and the magnitude of the preload force provided by the first pressing assembly 22 may be within 0-10N.

As shown in FIGS. 2, 3, and 4, the first stator assembly 23 includes a first elastomer 231 in contact with the first friction member 25, and a first piezoelectric ceramic body 232 fixed to a side of the first elastomer 231 away from the first friction member 25. The first piezoelectric motor 2 further includes a first circuit board 24 fixed to a side of the first piezoelectric ceramic body 232 away from the first elastomer 231 and in contact with the first pressing assembly 22. The first elastomer 231 is elastic and the first piezoelectric ceramic body 232 expands or contracts when energized, thereby exciting ultrasonic vibrations within the first elastomer 231 in contact with the first piezoelectric ceramic body 232. This vibration is transmitted to the first friction member 25 in close contact with the first elastomer 231 thereby driving the first guide 211 in contact with the first friction member 25 to move. The first circuit board 24 is electrically connected to the first piezoelectric ceramic body 232, and a certain high-frequency alternating voltage is applied to the polarized first piezoelectric ceramic body 232 by the first circuit board 24 to cause the first piezoelectric ceramic body 232 to expand or contract in response to a change in the amplitude of the high-frequency voltage.

According to the practical need, there may be a plurality of the first piezoelectric ceramic bodies 232. The first elastomer 231 and the first piezoelectric ceramic body 232 may be bonded and fixed. The first circuit board 24 and the first piezoelectric ceramic body 232 may be soldered and fixed, and the first circuit board 24 may be a flexible circuit board.

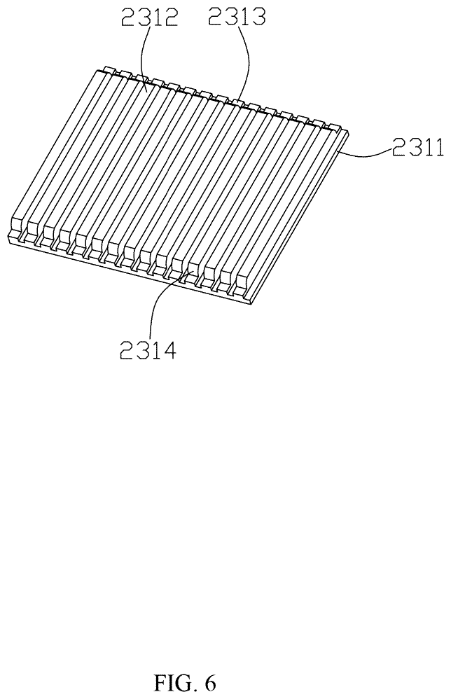

As shown in FIGS. 3 and 6, the first elastomer 231 includes a first base portion 2311 in contact with the first piezoelectric ceramic body 232, and a first elastic portion 2312 fixed to the first base portion 2311 and in contact with the first friction member 25. There may be a plurality of first elastic portions 2312, which are provided in spaced arrays so as to increase the elasticity of the first elastomer 231. According to practical needs, the first base portion 2311 and the first elastic portion 2312 may be connected as a single unit, and the plurality of first elastic portions 2312 are distributed at equally spaced intervals along the lengthwise direction of the guide member 6.

As shown in FIGS. 3, 5, and 6, in some embodiments, a first positioning groove 2313 is provided between one end of the first elastic portion 2312 and the first side plate 221, and a second positioning groove 2314 is provided between the other end of the first elastic portion 2312 and the third side plate 223. Opposite side of the first friction member 25 along the lengthwise direction are provided with a first positioning portion 251 and a second positioning portion 252, respectively. The first positioning portion 251 and the second positioning portion 252 are provided protruding relative to the surface of the first friction member 25. The first positioning portion 251 is assembled in the first positioning groove 2313, and the second positioning portion 252 is assembled in the second positioning groove 2314, so as to realize rapid assembly between the first friction member 25 and the first elastomer 231.

The working principle of the first piezoelectric motor 2 is explained by way of example below.

When a high-frequency voltage with a phase difference of 90° is applied to two adjacent first piezoelectric ceramic bodies 232 bonded to the first elastomer 231, one of the two first piezoelectric ceramic bodies 232 expands, and the other contracts. A standing wave is generated in each of the two regions corresponding to the first elastomer 231, and the two standing waves are synthesized into a traveling wave that travels along the circumference of the first elastomer 231, thereby causing the plasmas on the surface of the first elastomer 231 to form an ultrasonic microscopic vibration with a certain motion trajectory (usually an elliptical trajectory). The amplitude of the ultrasonic microscopic vibration is generally a few microns, and this microscopic vibration causes a continuous macroscopic movement of the first guide rail 211 (moving body) along a certain direction (against the direction of propagation of the traveling wave), i.e., a movement of the first guide plate 211 along the lengthwise direction of the guide member 6, by means of the friction between the first elastomer 231 (vibrating body) and the first guide plate 211 (moving body).

As shown in FIGS. 1, 2, and 4, the second piezoelectric motor 3 includes a second actuator assembly 31 fixed to the second lens assembly 5, a second pressing assembly 32 fixed to the second actuator assembly 31 and enclosing to form a second holding cavity with the second actuator assembly 31, a second stator assembly 33 in contact with the second actuator assembly 31 and the second pressing assembly 32 and provided within the second holding cavity. The second pressing assembly 32 is configured to press the second actuator assembly 31 and the second stator assembly 33 against the second friction member 35, and the second stator assembly 33 is configured to drive the second actuator assembly 31 to move along the lengthwise direction of the guide member 6, so that the second actuator assembly 31 drive the second lens assembly 5 to move, thereby achieving a continuous optical zoom of the second lens assembly 5.

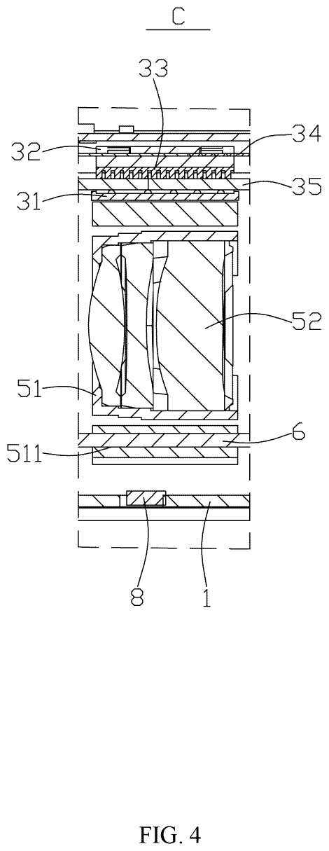

As shown in FIGS. 2 and 4, the second lens assembly 5 includes a second lens barrel 51 slidably assembled to the guide member 6 and provided within the holding cavity 11, and a plurality of second lenses 52 mounted within the second lens barrel 51. The plurality of second lenses 52 are distributed along the optical axis of the camera module, and the second actuator assembly 31 is fixedly connected to an outer side of the second lens barrel 51, so as to enable the second lens assembly 5 to move with the second actuator assembly 31, thereby achieving the continuous optical zoom of the second lens assembly 5.

It should be understood that the second piezoelectric motor 3 further includes a second circuit board 34. The second actuator assembly 31, the second pressing assembly 32, the second stator assembly 33, the second circuit board 34, and the second friction member 35 in the second piezoelectric motor 3 are set up in the same manner as the first actuator assembly 21, the first pressing assembly 22, the first stator assembly 23, the first circuit board 24, and the first friction member 25 in the first piezoelectric motor 2, and the second piezoelectric motor 3 operates on the same principle as the first piezoelectric motor 2. In order to avoid repetitive descriptions, the various components of the second piezoelectric motor 3 will not be described in detail herein.

It should be noted that the second circuit board 34 may be a flexible circuit board, the second circuit board 34 and the first circuit board 24 may be integrally provided, and the first friction member 25 and the second friction member 35 may be integrally provided.

As shown in FIG. 2, the first lens assembly 4 is provided with a first mounting cavity 411, and the second lens assembly 5 is provided with a second mounting cavity 511. The first mounting cavity 411 and the second mounting cavity 511 are coaxially provided, and the guide member 6 is slidingly assembled in the first mounting cavity 411 and the second mounting cavity 511, which not only allows the guide member 6 to orientate the movement of the first lens assembly 4 and the second lens assembly 5, but also ensures that the movement trajectories of the first lens assembly 4 and the second lens assembly 5 are consistent, thereby realizing the unity of the optical axis. According to practical needs, the guide member 6 may be a guiding rod, and the length of the guiding rod extends along the optical axis direction of the camera module.

As shown in FIG. 2, the camera module further includes a first position sensor 7 fixed to the housing 1 and provided within the holding cavity 11, and a second position sensor 8 fixed to the housing 1 and provided within the holding cavity 11. A detecting direction of the first position sensor 7 is directed toward the first lens assembly 4, so that the first position sensor 7 can collect the position of the first lens assembly 4 in real time. A detecting direction of the second position sensor 8 is directed toward the second lens assembly 5, so that the second position sensor 8 can collect the position of the first lens assembly 4 in real-time. The second lens assembly 5, so that the second position sensor 8 can collect the position of the second lens assembly 5 in real time to achieve closed-loop driving. According to practical needs, a first magnetic scale and a second magnetic scale are provided on an outer side of the first lens barrel 41 and an outer side of the second lens barrel 51, respectively, so that the first position sensor 7 and the second position sensor 8 detect real-time positions of the first lens assembly 4 and the second lens assembly 5 by recognizing the positions of the first magnetic scale and the second magnetic scale, respectively.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A camera module, comprising:
a housing having an accommodating cavity;
a first piezoelectric motor and a second piezoelectric motor provided within the accommodating cavity;
a first lens assembly connected to the first piezoelectric motor and provided within the accommodating cavity;
a second lens assembly connected to the second piezoelectric motor and provided within the accommodating cavity; and
a guide member fixed to the housing and provided within the accommodating cavity;
wherein the first lens assembly and the second lens assembly are spaced apart and both slidingly assembled to the guide member; the first piezoelectric motor is configured to drive the first lens assembly to move along a lengthwise direction of the guide member, and the second piezoelectric motor is configured to drive the second lens assembly to move along the lengthwise direction of the guide member.

2. The camera module of claim 1, wherein the first piezoelectric motor comprises a first actuator assembly fixed to the first lens assembly, a first pressing assembly fixed to the first actuator assembly and enclosing a first holding cavity with the first actuator assembly, a first stator assembly in contact with the first actuator assembly and the first pressing assembly and provided within the first holding cavity, and a first friction member in contact with the first actuator assembly and the first stator assembly and provided within the first accommodating cavity, wherein the first pressing assembly is configured to press the first actuator assembly and the first stator assembly against the first friction member, and the first stator assembly is configured to drive the first actuator assembly to move along the lengthwise direction of the guide member.

3. The camera module of claim 2, wherein the first actuator assembly comprises a first guide rail fixed to the first lens assembly and the first pressing assembly, and a first ball in contact with the first friction member and the first guide rail, wherein the first guide rail is provided with a first holding groove, and the first ball is provided within the first holding groove.

4. The camera module of claim 3, wherein the first pressing assembly comprises a first side plate fixed to the first guide rail, a second side plate fixed to the first side plate and provided directly opposite to the first guide rail, a third side plate fixed to the second side plate and connected to the first guide rail, and a first elastic piece provided on the second side plate and in contact with the first stator assembly, wherein the first guide rail, the first side plate, the second side plate, and the third side plate together enclose to form the first holding cavity.

5. The camera module of claim 2, wherein the first stator assembly comprises a first elastomer in contact with the first friction member, and a first piezoelectric ceramic body fixed to a side of the first elastomer away from the first friction member; wherein the first piezoelectric motor further comprises a first circuit board fixed to a side of the first piezoelectric ceramic body away from the first elastomer and in contact with the first pressing assembly, and the first circuit board is electrically connected to the first piezoelectric ceramic body.

6. The camera module of claim 5, wherein the first elastomer comprises a first base portion in contact with the first piezoelectric ceramic body, and first resilient portions fixed to the first base and in contact with the first friction member; wherein there are a plurality of the first resilient portions, and the plurality of the first resilient portions are provided in spaced arrays.

7. The camera module of claim 1, wherein the second piezoelectric motor comprises a second actuator assembly fixed to the second lens assembly, a second pressing assembly fixed to the second actuator assembly and enclosing to form a second holding cavity with the second actuator assembly, a second stator assembly in contact with the second actuator assembly and the second pressing assembly and provided within the second holding cavity assembly, and a second friction member in contact with the second actuator assembly and the second stator assembly and provided within the second accommodating cavity, wherein the second pressing assembly is configured to press the second actuator assembly and the second stator assembly against the second friction member, and the second stator assembly is configured to drive the second actuator assembly to move along the lengthwise direction of the guide member.

8. The camera module of claim 1, wherein the first lens assembly is provided with a first mounting cavity, and the second lens assembly is provided with a second mounting cavity; the first mounting cavity is coaxially disposed with the second mounting cavity, and the guide member is slidingly assembled within the first mounting cavity and the second mounting cavity.

9. The camera module of claim 1, further comprising a first position sensor fixed to the housing and provided within the accommodating cavity, and a second position sensor fixed to the housing and provided within the accommodating cavity, wherein a detecting direction of the first position sensor is directed toward the first lens assembly, and a detecting direction of the second position sensor is directed toward the second lens assembly.

10. An electronic device, comprising:
a device body; and
the camera module of claim 1, which is mounted in the device body.
